(19) United States
(12) Patent Application Publication
(10) Pub. No.: US 2025/0289077 A1
(43) Pub. Date: Sep. 18, 2025

(54) CORRECTIVE WELDING METHOD AND SEAM PROCESSING DEVICE FOR CORRECTIVE WELDING

(71) Applicant: TRUMPF Laser GmbH, Schramberg (DE)

(72) Inventors: Andreas Jahn, Dornhan (DE); Manuel Klaiber, Burladingen (DE); Martin Stambke, Aichhalden (DE)

(21) Appl. No.: 19/227,534

(22) Filed: Jun. 4, 2025

Related U.S. Application Data
(63) Continuation of application No. PCT/EP2023/083360, filed on Nov. 28, 2023.

(30) Foreign Application Priority Data
Dec. 9, 2022 (DE) 10 2022 132 824.4

(51) Int. Cl. B23K 26/24

(52) U.S. Cl. CPC B23K 26/24

(57) ABSTRACT

A method for corrective welding of workpieces is provided. At least a first workpiece of the workpieces has at least one faulty welding seam. The method includes providing the first workpiece that has the at least one faulty welding seam, capturing image data of the first workpiece using a camera, performing a first artificial intelligence-based image analysis of the image data in order to identify a seam position of the at least one faulty welding seam, performing a second artificial intelligence-based image analysis of the image data in order to identify at least one fault class of the at least one faulty welding seam, and determining whether a corrective welding of the at least one faulty welding seam is possible based on the seam position and the fault class of the at least one faulty welding seam.

### CROSS REFERENCE TO RELATED APPLICATIONS

This application is a continuation of International Application No. PCT/EP2023/083360 (WO 2024/120894 A1), filed on Nov. 28, 2023, and claims benefit to German Patent Application No. DE 10 2022 132 824.4, filed on Dec. 9, 2022. The aforementioned applications are hereby incorporated by reference herein.

### FIELD

Embodiments of the present invention relate to a method for corrective welding and a seam processing device for corrective welding.

### BACKGROUND

When welding workpieces, faults can occur in the welding seam, which can be categorized into different fault classes. If a fault occurs in a welding seam, the workpieces can undergo a corrective welding in a post-processing station. At present, the corrective welding is carried out manually by a worker, as the positioning of the faulty workpiece cannot be solved algorithmically for all fault classes. The worker also decides whether a corrective welding is possible and, if so, which welding parameters and/or scanner geometry will be used for the corrective welding.

Due to their cognitive abilities, humans are particularly well suited for “manual” or human evaluation of the workpiece with regard to the position and fault class of the welding seam. Nevertheless, the human evaluation of workpieces requires training and experience, is subjective, prone to errors and time- and resource-intensive. Therefore, “manual” evaluation is unsuitable in many cases if a reliable high throughput is required when analyzing large quantities of workpieces in real time. Automated, fast and reliable computer-aided image recognition and analysis is desirable.

### SUMMARY

Embodiments of the present invention provide a method for corrective welding of workpieces. At least a first workpiece of the workpieces has at least one faulty welding seam. The method includes providing the first workpiece that has the at least one faulty welding seam, capturing image data of the first workpiece using a camera, performing a first artificial intelligence-based image analysis of the image data in order to identify a seam position of the at least one faulty welding seam, performing a second artificial intelligence-based image analysis of the image data in order to identify at least one fault class of the at least one faulty welding seam, and determining whether a corrective welding of the at least one faulty welding seam is possible based on the seam position and the fault class of the at least one faulty welding seam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic sequence of training a deep convolutional network for a first and/or a second image analysis according to some embodiments;

FIG. 2 shows a schematic sequence of training an artificial intelligence (AI) for a first and/or a second image analysis using a few-shot/one-shot training approach according to some embodiments; and

FIG. 3 shows a schematic sequence of a method for corrective welding according to some embodiments.

### DETAILED DESCRIPTION

Embodiments of the invention provide a method for corrective welding of workpieces which have at least one faulty welding seam, which is fast, reliable and/or can be at least partially automated.

According to some embodiments, the method, in particular the computer-implemented method, for corrective welding of workpieces which have at least one faulty welding seam, comprises the following steps, in particular in the order stated. A faulty workpiece which has at least one faulty welding seam is provided in a seam processing device. A camera device is used to capture image data of the workpiece, in particular of the welding seam. Subsequently, a first artificial intelligence-based image analysis of the image data is carried out in order to identify a seam position of the at least one welding seam. Accordingly, the absolute or relative seam position of the welding seam is known, wherein the relative seam position refers to the seam processing device, in particular the camera device and/or the laser device. In addition, a second artificial intelligence-based image analysis of the image data is carried out in order to identify at least one fault class of the at least one welding seam. Consequently, the fault class of the welding seam, i.e., the type of welding seam fault, is known. On the basis of the identified seam position and/or the identified fault class of the at least one welding seam, it is then checked whether a corrective welding of the at least one welding seam is possible (correction suitability check). It is conceivable that some welding faults or fault classes are not suitable for corrective welding. Suitability may depend, for example, on the capability and parameters of a seam processing device, in particular a laser device.

As a result, it is possible to check automatically, quickly and reliably whether a faulty welding seam can undergo, particularly in a practical sense, a corrective welding. In this regard, the classification of welding faults is deterministic and is not subject to fluctuations due to the subjective assessment of different workers. The subsequent determination of the welding parameters can still be carried out manually.

If the check shows that a corrective welding is possible, particularly in a practical sense, then it is advantageous if the welding parameters are determined on the basis of the identified seam position and/or the identified fault class of the at least one welding seam. This makes post-processing even faster and more reliable, and further steps of the method can be automated. In this regard, the determination of the welding parameters is based on the information determined for checking whether a corrective welding is possible, in particular the seam position and/or fault class.

The description further comprises a method for corrective welding of workpieces which have at least one faulty welding seam, comprising the following steps, in particular in the order stated:
providing the workpiece which has at least one faulty welding seam;
capturing image data of the workpiece using a camera device;
carrying out a first artificial intelligence-based image analysis of the image data in order to identify the seam position of the at least one welding seam;
carrying out a second artificial intelligence-based image analysis of the image data in order to identify at least one fault class of the at least one welding seam; and
determining welding parameters on the basis of the identified seam position and/or the identified fault class of the at least one welding seam.

Computer-aided image analysis solutions comprise artificial intelligence (AI) methods based on machine learning (ML), in particular deep learning techniques that use artificial neural networks (ANN). When the term “artificial intelligence” (AI) is used in this document, it refers, for example, to machine learning (ML) methods, preferably deep learning. The currently most widely used variant for training an AI is known as “supervised learning”. This involves using training data to train the AI towards one or more specific goals or tasks. For training, the AI is therefore presented with combinations of training images and the corresponding result on which the AI is to be trained, i.e., a sample solution (“labels”, “annotations”, “ground truth”) for the task to be solved using the images. This combination of training images and sample solutions enables the AI to learn the task set, check and correct its results and thus undergo successful training.

The term “fault classes” herein are to be understood as different types of faults in welding seams. Faults in welding seams can be, for example: Pores and bubbles, inclusions, cracks, interruptions and defects, incomplete penetration or fusion, overfilling or underfilling, distortion or deformation, tarnishing and oxidation. Different welding strategies can be selected depending on the seam position and/or fault class of the welding seam fault. The welding strategy is determined, among other things, by the welding parameters of a seam processing device, in particular a laser device.

An advantageous further development provides that the first artificial intelligence-based image analysis and/or the second artificial intelligence-based image analysis comprises a deep convolutional network. Convolutional neural networks (CNNs) are a class of deep, feedforward neural networks used in image processing (e.g. image recognition), sound processing (e.g. speech recognition) and similar fields. A convolutional layer in a deep convolutional network applies a convolution operation to its input and passes the result to the next layer. In general, deep convolutional networks use relatively little pre-processing, which means that the network learns the filters, which were developed manually in traditional algorithms, making them more independent of existing knowledge and human efforts in feature design.

The artificial intelligence for the first image analysis and the artificial intelligence for the second image analysis can be designed as a joint artificial intelligence.

In order to determine the seam position of the welding seam, image data, in particular one or more camera images, are preferably captured by the camera device. The AI for the component position and/or seam position detection recognizes the seam position of the welding seam using a deep convolutional network. Here, a decision is made on a pixel-by-pixel basis in the image data as to whether a pixel belongs to the welding seam or not. Depending on the workpiece, other classes (e.g.: non-welded hairpin surfaces on hairpins) are taken into account during component position detection and transferred as information to the downstream correction suitability check and/or parameter adjustment. Once the seam position has been precisely determined, the workpiece, in particular the at least one welding seam, can preferably be aligned with a laser device in order to ensure optimum corrective welding.

The AI for the fault class detection, in particular the classifier, can be a deep convolutional network that has been trained in advance with representative data of the individual fault classes, as is the case with the AI for component position and/or seam position detection. The trained network calculates a probability vector for each input, which indicates how likely it is that the current input belongs to the respective fault class. With this approach, new fault classes are taught by a new training process with all data.

Alternatively or additionally, the AI can be trained for fault class detection using a few-shot/one-shot training approach. This involves advance, preferably one-time, training of the AI, which learns a specific metric in order to differentiate between data. The metric can be seen as a more abstract capability in relation to the deep convolutional network. This trained model is preferably located on a computing unit and requires only a few pieces of sample data of a fault class in order to carry out the classification. In addition, this approach is able to learn new fault classes during ongoing operation. A computationally intensive training of the network is preferably not necessary. By implementing the few-shot/one-shot training approach, it is also easy to introduce new fault classes and welding strategies directly on the system.

In order to improve the classification, sensor data is preferably acquired using a sensor device, wherein the identification of the fault class is also carried out on the basis of the sensor data. The sensor device preferably carries out an optical coherence tomography and/or light section and/or triangulation method and/or 3D reconstruction.

It is furthermore advantageous if the seam shape and/or the center of mass of the at least one welding seam is identified in the second artificial intelligence-based image analysis, and wherein the welding parameters are determined on the basis of the identified seam shape and/or the identified center of mass. This further increases the reliability of the method.

A further advantageous embodiment of the invention provides that information for checking whether a corrective welding is possible and/or about the welding parameters is transmitted to a laser device. It is advantageous if the corrective welding is carried out using a laser device with the determined welding parameters. The result of the classification is transferred together with the parameters from the first AI to an algorithm that selects the welding parameters based on the classification. In addition, numerical parameters can be adapted to the respective welding situation based on the sensor data, e.g. shape and/or center of mass. The result of this algorithm is transferred to the laser and the corrective welding is carried out with the parameters.

Preferably, the camera device captures 2D image data. Preferably, a third artificial intelligence-based image analysis is carried out, in which 3D image data is generated from the 2D image data. The 2D and/or 3D image data is preferably used to identify the seam position and/or the fault class and/or the welding parameters.

Embodiments of the invention also provide a seam processing device. The seam processing device for corrective welding of workpieces which have at least one faulty welding seam comprises a camera device for capturing image data of the workpiece, a computing unit for carrying out image analyses and a laser device for carrying out corrective welding of the at least one welding seam. The computing unit is configured such that a first artificial intelligence-based image analysis of the image data in order to identify a seam position of the at least one welding seam is carried out, a second artificial intelligence-based image analysis of the image data in order to identify a fault class of the at least one welding seam is carried out and a check is made as to whether a corrective welding of the at least one welding seam is possible on the basis of the identified seam position and the fault class of the at least one welding seam.

It is advantageous if the computing unit is further configured to determine welding parameters on the basis of the identified seam position and fault class of the at least one welding seam, wherein the laser device is configured to carry out the corrective welding of the at least one welding seam with the determined welding parameters. The computing unit can furthermore be configured to control the laser device.

It is also advantageous if the seam processing device furthermore comprises a sensor device for generating sensor data, in particular based on an optical coherence tomography and/or a light section and/or a triangulation method and/or a 3D reconstruction. The computing unit furthermore preferably identifies the fault class on the basis of the sensor data.

Preferably, the laser device comprises a laser beam source for generating a laser beam, a processing optics system for deflecting the laser beam, and a camera device, wherein the camera device is arranged coaxially to the laser beam on the processing optics system. Both a scanner (PFO) and fixed optics can preferably be used as the processing optics system. With fixed optics, an axis system must assume the task of tracking the optics.

The setup corresponds preferably to a standard setup of Trumpf's VisionLine on a processing optics system with a laser. Optionally, VisionLine 3D can be used with an OCT sensor if the 3D information provides important information for fault classification. Alternatively, the 3D information can be calculated from the 2D image using a further AI. Here, the VisionLine camera is directed coaxially at the component from above. The PanelPC from VisionLine can be used as a computing unit and calculates both the neural networks and the algorithm for determining the welding strategy. In an initial expansion stage, this strategy selection can be made using a look-up table approach (Active Process Logic-APL) in VisionLine. The result is transmitted to the laser device via the VisionLine network connection.

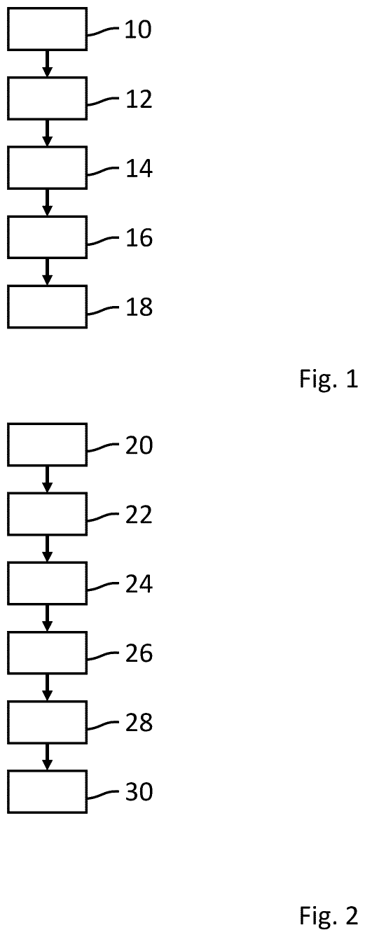

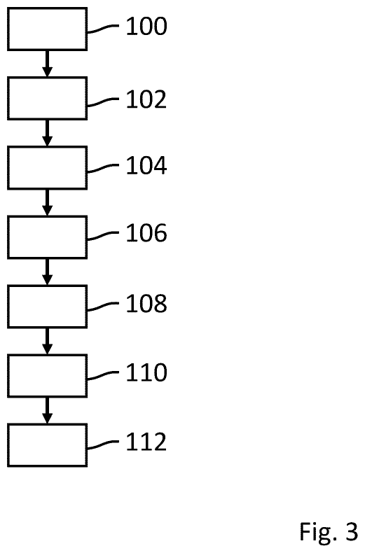

A first and second image analysis according to FIG. 3 are used to identify a seam position and/or a fault class of at least one faulty welding seam. The image analysis is based on an AI, which can be trained according to FIG. 1 and/or FIG. 2.

The AI shown in FIG. 1 is based on a deep convolutional network. In order to train such an AI, data preparation 10 is required first. This includes a data collection of labeled or designated examples, such as welding seams on a workpiece and/or welding seams with welding faults of different fault classes. In order to make the model more robust, further examples can be generated by subjecting the existing examples to a rotation, mirroring or cropping, for example. The data set can furthermore be divided into training, validation and test sets. This is followed by the determination of a model architecture 12. In this regard, the types and number of layers that the network should have are selected. This comprises convolutional layers, pooling layers, activation functions and fully connected layers. Training 14 then takes place by first passing an input data set with workpieces and/or welding seams through the network, wherein all calculations are carried out in each layer. The result of the calculations is compared with the labeled value, i.e., the actual welding seam and/or the actual fault class, in order to calculate the fault. The loss quantifies how well or poorly the model fulfills the task. Finally, the fault is run backwards through the network in order to adjust the weightings in each layer. After the training has been completed, the network is validated and adjusted 16. The network is tested using the validation set in order to verify the performance. Depending on the error rate with respect to the validation set, parameters such as learning rate, number of layers or type of activation function can be adjusted. Finally, the network is evaluated using the test set. Various performance metrics (accuracy, F1 score, etc.) are calculated in order to assess the quality of the network.

The AI shown in FIG. 2 is trained using a few-shot/one-shot training approach. According to step 20, the data is also prepared, wherein a data set with far fewer examples per class is required for few-shot and one-shot learning. The data set is also divided into training, validation and test sets. According to step 22, a base model is selected which is fine-tuned for the specific task, in this case the identification of the welding seam and/or the fault class. According to step 24, an architecture is selected which is particularly suitable for the identification of welding seams and/or fault classes. Siamese networks or triplet networks and meta-learning, such as MAML (Model-Agnostic Meta-Learning), are suitable for this purpose. The training according to step 26 is carried out using episodic training: In each training episode, a small selection of classes and examples is chosen at random. The model is then briefly trained on this small data set. Loss functions specialized to the small data set, such as a triplet loss, can be used to train the network by encouraging it to place similar things closer and different things farther apart in the feature space. The network 28 is subsequently validated here too. Finally, the test is carried out in accordance with step 30, wherein the network is evaluated using a test set or new classes that it has not yet seen. Performance metrics are particularly important to assess the ability of the model to generalize to new, unknown data.

The AIs trained according to FIGS. 1 and/or 2 can be used for the method for corrective welding according to FIG. 3. For this purpose, a workpiece which has at least one faulty welding seam is provided in accordance with step 100. A camera device is used to capture image data of the workpiece according to 102. Subsequently, a first artificial intelligence-based image analysis, in particular trained with a method according to FIGS. 1 and/or 2, is carried out according to step 104 in order to identify a seam position of the at least one welding seam from the image data. In addition, according to step 106, a second artificial intelligence-based image analysis, in particular trained with a method according to FIGS. 1 and/or 2, is carried out in order to identify at least one fault class of the at least one welding seam from the image data, in particular the same image data.

Depending on the seam position and/or the fault class, step 108 checks whether a corrective welding of the at least one welding seam is possible. If a positive evaluation is made, welding parameters are furthermore determined according to step 110 on the basis of the identified seam position and/or the identified fault class of the at least one welding seam. The seam position and the welding parameters are then fed to a laser device, wherein the laser device carries out a corrective welding of the faulty welding seam using the welding parameters in accordance with step 112. Finally, the workpiece or the welding seam can be run through the method again in order to check whether the welding fault has been rectified and/or whether an existing welding fault can be corrected again.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for corrective welding of workpieces, at least a first workpiece of the workpieces having at least one faulty welding seam, the method comprising:
providing the first workpiece that has the at least one faulty welding seam;
capturing image data of the first workpiece using a camera;
performing a first artificial intelligence-based image analysis of the image data in order to identify a seam position of the at least one faulty welding seam;
performing a second artificial intelligence-based image analysis of the image data in order to identify at least one fault class of the at least one faulty welding seam; and
determining whether a corrective welding of the at least one faulty welding seam is possible based on the seam position and the fault class of the at least one faulty welding seam.

2. The method according to claim 1, further comprising, upon determining that the corrective welding of the at least one faulty welding seam is possible:
determining welding parameters based on the seam position and/or the fault class of the at least one faulty welding seam.

3. The method according to claim 1, wherein the first artificial intelligence-based image analysis and/or the second artificial intelligence-based image analysis comprises a deep convolutional network.

4. The method according to claim 1, wherein training data of individual fault classes is provided to the second artificial intelligence-based image analysis for training purposes, and/or wherein the training data is provided in a few-shot and/or one-shot training approach to the second artificial intelligence-based image analysis for teaching a specific metric in order to distinguish the image data.

5. The method according to claim 1, further comprising acquiring sensor data by at least one sensor, wherein the identifying the fault class is performed further based on the sensor data.

6. The method according to claim 5, wherein an optical coherence tomography and/or a light section and/or a triangulation method and/or a 3D reconstruction is/are performed by the sensor.

7. The method according to claim 2, wherein a seam shape and/or a center of mass of the at least one faulty welding seam is identified in the second artificial intelligence-based image analysis, and wherein the welding parameters are determined based on the seam shape and/or the center of mass.

8. The method according to claim 2, further comprising transmitting information for the determining whether the corrective welding is possible and/or the welding parameters to a laser device, and wherein the corrective welding is performed by the laser device with the welding parameters.

9. The method according to claim 1, wherein the image data captured by the camera comprise 2D image data, the method further comprising performing a third artificial intelligence-based image analysis in order to generate 3D image data from the 2D image data.

10. A seam processing device for corrective welding of workpieces, at least a first workpiece of the workpieces having at least one faulty welding seam, the seam processing device comprising:
a camera for capturing image data of the first workpiece,
a computer for performing image analyses of the image data, and
a laser device for performing a corrective welding of the at least one faulty welding seam,
wherein the computer is configured to:
perform a first artificial intelligence-based image analysis of the image data in order to identify a seam position of the at least one faulty welding seam,
perform a second artificial intelligence-based image analysis of the image data in order to identify a fault class of the at least one faulty welding seam,
determine whether a corrective welding of the at least one faulty welding seam is possible based on the seam position and the fault class of the at least one faulty welding seam.

11. The seam processing device according to claim 10, wherein the computer is further configured to:
determine welding parameters based on the seam position and the fault class of the at least one faulty welding seam,
wherein the laser device is configured to perform the corrective welding of the at least one faulty welding seam with the welding parameters.

12. The seam processing device according to claim 10, further comprising a sensor for generating sensor data, wherein the computer is configured to identify the fault class further based on the sensor data.

13. The seam processing device according to claim 10, wherein the laser device comprises:
a laser beam source for generating a laser beam, and
a processing optics system for deflecting the laser beam,
wherein the camera is arranged coaxially to the laser beam on the processing optics system.
